(19) United States
(12) Patent Application Publication
(10) Pub. No.: US 2007/0003128 A1
(43) Pub. Date: Jan. 4, 2007

(54) A Method Of Aligning A Pattern On A Workpiece

(75) Inventors: Rhonda M. Anderson, Verbank, NY (US); James N. Humenik, LaGrangeville, NY (US); Robert P. Katz, LaGrangeville, NY (US); Benedikt M. Kellner, Wappingers Falls, NY (US); Keith C. O'Neil, Hughsonville, NY (US); Randall J. Werner, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, ARMONK, NY (US)

(21) Appl. No.: 11/160,570

(22) Filed: Jun. 29, 2005

(51) Int. Cl. G06K 9/00

(52) U.S. Cl. 382/151

(57) ABSTRACT

A first set of fiducials is formed in fiducial locations on a workpiece such as a ceramic greensheet; a pattern is formed in the workpiece; a best fit set of fiducials is formed by a least squares technique based on the pattern; and a second set of fiducials is formed over the fiducial locations of the best fit set.

### TECHNICAL FIELD

The field of the invention is that of aligning a pattern projected on a workpiece with respect to reference marks, in particular aligning a set of punched apertures on a ceramic greensheet.

### BACKGROUND OF THE INVENTION

In the course of manufacturing a ceramic integrated circuit holder, a set of ceramic greensheets are formed with a pattern, usually by punching holes placed relative to a set of fiducial reference marks. The set of greensheets is aligned in a stack and fired to form a block in which the pattern of holes in the various layers line up to form conductive vias that will carry signals vertically between different layers.

It is known that the punching process and other causes cause the pattern of holes to be distorted from the initially designed pattern.

One approach that is known in the art is to use laser drilling rather than mechanical punching of the vias. This approach is not yet in commercial use and has some practical problems to overcome.

Another approach is the use of the use of optical alignment features on each layer of the laminate, as shown in IMAPS-CII/NEMI Technology Roadmaps—December 2002. This approach would require a large capital investment for tooling.

The art could benefit from a method of aligning the various layers of a ceramic laminate that uses primarily standard tooling at relatively low cost.

### SUMMARY OF THE INVENTION

The invention relates to a method of aligning patterns in a set of corresponding layers such that vertically adjacent layers have corresponding features within a tolerance; i.e. two or more vertically adjacent conductive members that are meant to form a vertical conductive path are within a tolerance value such that a minimum overlap between adjacent layers is maintained.

A feature of the invention is that a pattern is defined on an nth layer relative to a first set of fiducial reference marks.

A feature of the invention is the measurement of a subset of pattern features in each layer and the computation of best fit locations of a second set of fiducial marks that maintain the subset of pattern features within a tolerance value of their ideal locations.

Another feature of the invention is the formation of a second set of fiducial reference marks at the best fit locations.

### BRIEF DESCRIPTION OF THE DRAWINGS

FIG. 1 shows a plan view of a sample pattern with the first set of fiducials and the best fit locations indicated.

FIG. 2 shows the plan view of FIG. 1 with the addition of the second set of fiducials.

FIG. 3 shows a simplified view of a measurement apparatus.

### DETAILED DESCRIPTION

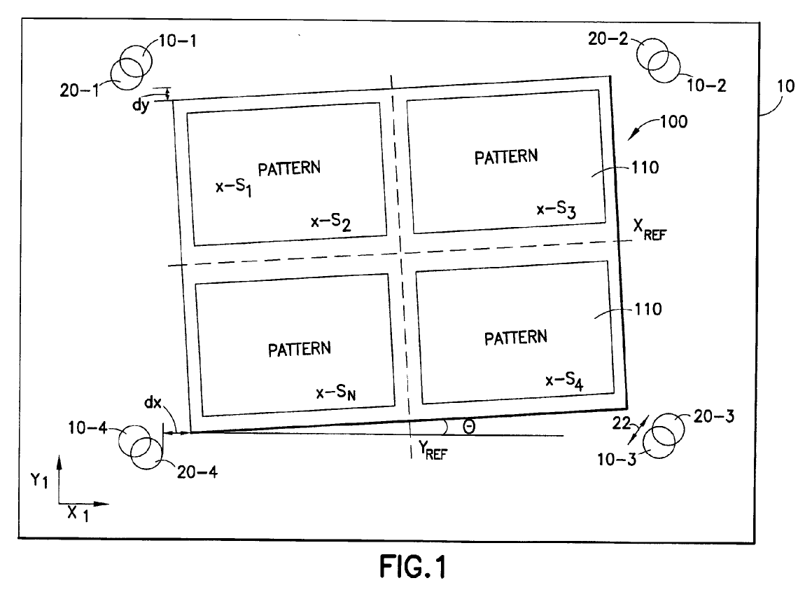

FIG. 1 shows a plan view of a workpiece 10, such as a ceramic greensheet, having a pattern 100 comprising four blocks 110 formed in it. In the example of a greensheet, the preferred method of defining a pattern is by mechanically punching apertures through the material of the greensheet. In the case of a mask for a stepper in integrated circuit fabrication, a wafer for fabricating integrated circuits or printed circuit boards, the method of defining a pattern may be by projecting an alignment mark onto a photosensitive material, then developing the photo-material and etching the underlying substrate to form the marks.

A first set of marks 10-1 through 10-4 represent a first set of fiducial reference marks, in this case represented schematically by circles. The first set of fiducials will be formed within a set of nominal reference mark spaces. The pattern 100 has been distorted to represent the effect of various causes of distortion such as mechanical stress on the greensheet material and distortion in the pattern-defining mechanism, or in the general setup of the punch tool/die itself. In the case of a greensheet, the mechanical drivers that move the punch (or move the workpiece under the punch) will not be perfectly linear and will introduce distortion. The pattern is defined with respect to axes x1 and y1 and the distortion is denoted by dx on the lower left, dy on the upper left and angle theta on the bottom of FIG. 1.

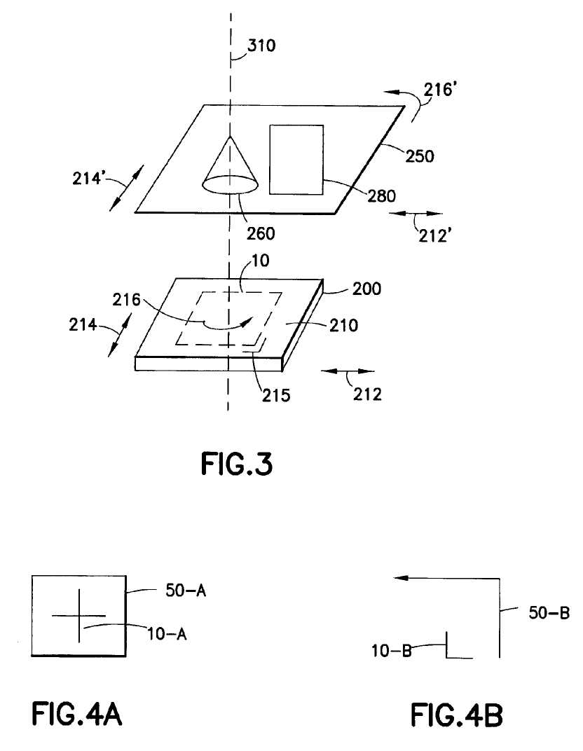

After the pattern 100 has been defined, a sample set of sample marks S1 through SN will be measured with respect to reference axes Xref and Yref by an apparatus shown in FIG. 3 and a “best fit” set of fiducials will be defined by an algorithm as described below.

The location of the best fit fiducials is denoted by marks 20-1 through 20-4, which are close to the first set; i.e. within a fiducial tolerance amount denoted by arrow 22 in the lower right of the figure, showing the tolerable deviation between the two sets of fiducials. Ordinarily, the set of best fit fiducials 20 will not be marked on the workpiece as shown in FIG. 1.

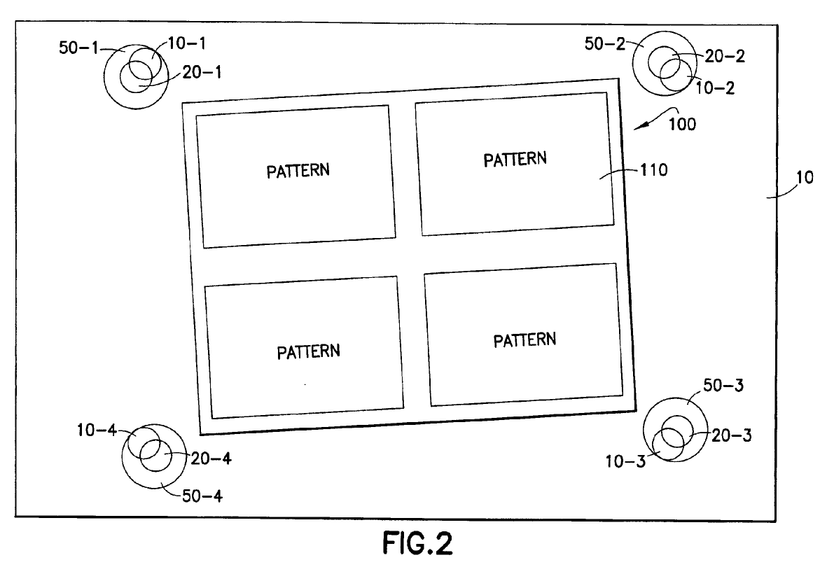

FIG. 2 shows the same pattern 100 as FIG. 1, with the addition of a second set of fiducials 50-1 through 50-4 that are centered on the set of best fit fiducial locations 20-1 through 20-4 and are sufficiently larger than the first set that they enclose the fiducials marks of the first set of fiducials.

This is an advantageous feature of the invention that the two sets of fiducials marks occupy the same locations on the workpiece. Space on a workpiece is typically scarce, so that it is advantageous that the final set of fiducials is not interfered with by the first set. This is accomplished by having the first set of fiducials undersized with respect to the final set by an amount that depends on the tolerance 22 such that the second set of fiducials covers the first set when the first set is within the tolerance amount of the best fit set of fiducial locations. As a result, the first set of marks disappears and there is no wasted space and no possibility of confusion between the two sets of marks.

The several greensheets will then be aligned using the final fiducials 50, giving an alignment between the sheets that is within an intersheet tolerance that is set such that a desired minimum overlap between holes in vertically adjacent sheets is maintained. If the difference between the best fit locations 20 and the first set of fiducials 10 is greater than a preset limit, that greensheet will be rejected and replaced by one that is within limits.

FIG. 3 illustrates schematically a system for measuring the sample marks and for marking the second set of fiducials. On the bottom of the figure, a flat surface 210 that is the top of a precision stage 200 contains a reference fixture 215, such as a pair of mechanical stops. Workpiece 10, denoted by dotted lines, has been placed on the flat surface, adjacent to the stops 215. Surface 210 is mounted on a precision stage that is adjustable in x, y and theta as denoted by arrows 212, 214 and 216.

An upper stage, also adjustable in x, y and theta as denoted by arrows 212′, 214′ and 216′, contains a camera 260 and a marking device 280 that marks the locations of the second set of fiducials. Illustratively, the upper stage is moved to place camera 260 on the z-axis 310 and lower stage 200 is moved to place the nominal position of the sample pattern elements on axis 310. Camera 260 measures the deviation of each sample element from its nominal position (the distance from axis 310).

Both the upper and lower stages will be referenced to a laboratory coordinate system (e.g. z-axis 310 and corresponding x and y axes) by conventional measurement techniques.

The number of sample positions that are measured will depend on a tradeoff between measurement time and the desired accuracy. It has been found that 16 is an appropriate number of samples for the greensheet example. Increasing the number of samples increases the time spent linearly and increases the measurement accuracy at a rate that is considerably less than linear. Those skilled in the art will readily be able to ascertain an appropriate number for their purposes.

After the best fit locations have been calculated as described below, the lower stage will be moved to place the best fit locations below the marking device and the new fiducial marks will be defined.

Box 280 in FIG. 3 represents schematically a punch for use in marking greensheets and a laser or electron beam to expose a photoresist in the case of an integrated circuit wafer or other workpiece that uses lithography to define the fiducials.

The best fit algorithm gives a transform that minimizes the difference between the nominal position of the sample points and their measured locations. Further, the transform also determines the orientation; i.e. the rotation of the fiducial pattern from its nominal position about the datum axes and minimizes the rotational error relative to the central axis as defined by the measured locations. The calculation of the best fit locations may illustratively be carried out by a conventional least squares best fit calculation; i.e. sum the quantity (X10-X50)²+(Y10-Y50)² over the sample points, and determine the rotational orientation error (theta) and minimize it, (where) X10 and Y10 are the coordinates of the sample points with respect to the initial set of fiducials and X50 and Y50 are the coordinates of the sample points with respect to the best fit fiducials.

FIGS. 4A and 4B illustrate various combinations of fiducials suitable for the first and second sets of fiducial marks. Marks 10-A and 10-B could be used for the first set of marks and marks 50-A and 50-B could be used for the second set. Mark 50-B could be used with mark 10-A and mark 50-A could be used with 10-B. In each case, the principle of having the first mark fall within the boundary of the second mark (also referred to as having the second set of fiducials cover the first set) when the tolerance is within limits is followed. In the case of circular punches, the first set of fiducials is physically removed. In other examples, such as those illustrated in FIG. 4, the first set of fiducials is sized, located and oriented such that the two sets are readily distinguished.

The lithographic marks illustrated in FIGS. 4A and 4B could be positive or negative with respect to the background (i.e. projecting or recessed). If the workpiece is sufficiently thin, the second mark could be an aperture that passes through the workpiece to expose the layer below (and a mark on that lower layer).

In the case of lithographic marks, those skilled in the art will be well aware of techniques for applying, exposing and developing photoresist and techniques for etching the workpiece to form marks that have been defined by the exposure.

In one example, the first and second sets of fiducials are both present. In another example, the fiducial locations are etched or filled to eliminate the first set and the final set of fiducials are formed in the same location.

While the invention has been described in terms of a single preferred embodiment, those skilled in the art will recognize that the invention can be practiced in various versions within the spirit and scope of the following claims.

What is claimed is:

1. A method of forming and aligning a pattern on at least one workpiece comprising the steps of:
forming a first set fiducial reference marks on said workpiece;
defining a pattern on said workpiece with respect to said first set of fiducial marks, said pattern comprising a set of pattern members;
measuring the locations of a sample set of pattern members with respect to a coordinate system;
calculating best fit location values of a final set of fiducial reference marks with respect to said sample set of pattern members; and
forming said final set of fiducial reference marks on said workpiece in said best fit location values.

2. A method according to claim 1 in which:
said first set of fiducial reference marks are smaller than a nominal reference mark space and said final set of fiducial reference marks are larger than said first set of fiducial reference marks by a tolerance amount such that said final set of fiducial reference marks covers said first set of fiducial reference marks.

3. A method according to claim 1, in which said set of fiducials are formed by mechanically removing workpiece material.

4. A method according to claim 3, in which said step of removing workpiece material comprises removing material to form an aperture extending through said workpiece.

5. A method according to claim 2, in which said set of fiducials are formed by mechanically removing workpiece material.

6. A method according to claim 5, in which said step of removing workpiece material comprises removing material to form an aperture extending through said workpiece.

7. A method according to claim 1, in which said first set of fiducials are formed lithographically.

8. A method according to claim 7, in which said first set of fiducials have a first shape and said final set of fiducials have a second shape different from said first shape.

9. A method according to claim 1, in which said at least one workpiece is a member of a set of workpieces; and
further comprising a step of positioning said at least one workpiece with respect to at least one other member of said set of workpieces.

10. A method according to claim 9, in which said set of fiducials are formed by mechanically removing workpiece material.

11. A method according to claim 10, in which said step of removing workpiece material comprises removing material to form an aperture extending through said workpiece.

12. A method according to claim 2, in which said at least one workpiece is a member of a set of workpieces; and
further comprising a step of positioning said at least one workpiece with respect to at least one other member of said set of workpieces.

13. A method according to claim 12, in which said set of fiducials are formed by mechanically removing workpiece material.

14. A method according to claim 13, in which said step of removing workpiece material comprises removing material to form an aperture extending through said workpiece.

15. A method of forming and aligning a pattern on a set of at least two workpieces comprising the steps of:
a) forming a first set of fiducial reference marks on a first workpiece of said set of at least two workpieces;
b) defining a pattern on said first workpiece with respect to said first set of fiducial marks, said pattern comprising a set of pattern members;
c) measuring the locations of a sample set of pattern members with respect to a coordinate system;
d) calculating best fit location values of a final set of fiducial reference marks with respect to said sample set of pattern members;
e) forming said final set of fiducial reference marks on said first workpiece in said best fit location values;
repeating steps a) through e) for other members of said set of at least two workpieces and aligning all members of said set of at least two workpieces using said final set of fiducial reference marks.

16. A method according to claim 15, in which:
said first set of fiducial reference marks are smaller than a nominal reference mark space and said final set of fiducial reference marks are larger than said first set of fiducial reference marks by a tolerance amount such that said final set of fiducial reference marks covers said first set of fiducial reference marks.

17. A method according to claim 15, in which said set of fiducials are formed by mechanically removing workpiece material.

18. A method according to claim 15, in which said first set of fiducials are formed lithographically.

19. A method according to claim 18, in which said first set of fiducials have a first shape and said final set of fiducials have a second shape different from said first shape.

20. A method according to claim 15, in which said set of at least two workpieces comprises a set of ceramic greensheets.
